(19) United States
(12) Patent Application Publication
(10) Pub. No.: US 2009/0260951 A1
(43) Pub. Date: Oct. 22, 2009

(54) Vibratory apparatus and method for inverting articles in a product stream

(76) Inventors: Eugen Groenewald, Woerden (NL); Mark M.B. Kivit, Zaltbommel (NL); Saeed Tasbihgou, Heelsum (NL)

Correspondence Address: MARK ALLISON BAUMAN, 1910 SUNFLOWER COURT, COLLEGE PLACE, WA, 99324, US

(21) Appl. No.: 12/148,714

(22) Filed: Apr. 21, 2008

(51) Int. Cl. B65G 47/248

(52) U.S. Cl. 198/411; 198/617

(57) ABSTRACT

The present invention is an apparatus and method for inverting or turning-over articles in a product stream as they are transported by a vibratory conveyor. The articles are transported along a vibratory surface in a vibratory manner to a curved surface that is bounded by a tapered guide wall. The objects are transported along the curved surface in a vibratory manner and partially rolled so that, as they release or transfer from the curved surface to a vibratory surface, they turn-over and become inverted. The invention is shown and discussed in the context of an advantageous seasoning application.

### TECHNICAL FIELD

The present invention relates in general to a system for turning or inverting articles in a stream of articles, and particularly to a system for turning or inverting articles in a stream of articles as they are transported by a vibratory conveyor.

### BACKGROUND OF THE INVENTION

The prior art is replete with scores of patents which describe various vibratory conveyor systems that convey and manipulate articles.

These vibratory conveying systems have traditionally been utilized for transporting a stream of articles from one machine to another in a production line. Such vibratory conveying systems have found acceptance in many industries, and have received exemplary acceptance in the food production industry. This acceptance in the food industry is understandable given the reputation of superior sanitation afforded by vibratory conveying systems over alternative conveying technologies.

In the production of snack foods, a coating or seasoning is often applied to enhance the taste of articles in a product stream. One method of applying seasoning includes transporting articles along a first conveyor beneath a first seasoning dispenser where one side of each article is coated. Then, the articles are passed or transferred to a second conveyor. During this transfer, some of the articles will turn or invert, exposing the uncoated side. Then, the articles are transported by the second conveyor beneath a second seasoning dispenser. In this method, some of the articles receive a double coating on one side and no coating on the opposite side due to the inefficiency of the inverting or turning of the articles during the transfer from the first to second conveyor.

An improved approach is taught in U.S. Pat. No. 6,591,777. Here, a first and second conveyor are each positioned at right angles to one another with the first conveyor positioned above the second conveyor. A transfer chute is positioned between the first and second conveyor to guide the articles during transfer from the first to the second conveyor to more efficiently invert or turn-over the articles.

Both of these approaches require the use of multiple conveyors which significantly increases the complexity, cost, and energy consumption of the overall system. In addition, additional factory floor space is required owing to the larger footprint of the multiple conveyors. Furthermore, multiple product drops from one conveyor to another can increase product damage and dislodge seasoning from the product.

A single conveyor solution that can accurately invert or turn-over articles would mitigate many of these shortcomings found in the prior art and is the subject of the present invention.

### SUMMARY OF THE INVENTION

A first aspect of the present invention is a vibratory apparatus for inverting articles in a product stream having a vibrating conveying surface with an infeed and a discharge and configured to transport the product steam from the infeed end to the discharge end in a flow direction, and a first guide wall positioned at an angle relative to the flow direction, and borne by the vibrating conveying surface, and a first curved surface positioned adjacent to a portion of the first guide wall, and borne by the vibrating conveying surface, and defining a path that is at least partially characterized by a ribbon with a half twist, and wherein the articles are transported by and along a portion of the first curved surface and are inverted or turned-over as they are transferred from the first curved surface to the vibrating conveying surface.

Another aspect of the invention is a vibratory apparatus for inverting articles in a product stream having a vibrating conveying surface with an infeed at a first elevation, and a discharge at a second elevation, and configured to transport the product steam from the infeed to the discharge in a flow direction, and a first guide wall positioned at an angle relative to the flow direction, and borne by the vibrating conveying surface, and wherein the first guide wall has a first end and an opposite second end, and wherein the first guide wall has a first height extending from the first end to an intermediate position between the first and second end, and a tapered region beginning at the intermediate position and extending to the second end, and a first curved surface positioned adjacent to a portion of the first guide wall, and borne by the vibrating conveying surface, and wherein the articles are transported by and along a portion of the first curved surface and are inverted or turned-over as they are transferred from the first curved surface to the vibrating conveying surface.

Yet another aspect of the invention is a method for inverting articles in a product stream that includes providing a vibrating conveying surface having an infeed and a discharge, and providing a first guide wall that is borne by the vibrating conveying surface, and having a first end and an opposite second end, and wherein the first guide wall has a first height extending from the first end to an intermediate position between the first and second end, and a tapered region beginning at the intermediate position and extending to the second end, and providing a first curved surface positioned adjacent to a portion of the first guide wall, and borne by the vibrating conveying surface, and transporting articles oriented with a first side facing in an upward manner from and along the vibrating conveying surface to the first curved surface, and transporting the articles along a portion of the first curved surface so that the articles begin to roll as they are urged toward the first guide wall, and releasing the articles from the first curved surface to the vibrating conveying surface so that the first side of the articles assume a downward facing direction as they contact the vibratory conveying surface, and transporting the articles oriented with the first side facing in a downward manner as they are transported to the discharge.

These and other aspects of the present invention will be described in greater detail hereinafter.

### BRIEF DESCRIPTION OF THE DRAWINGS

Preferred embodiments of the invention are described below with reference to the following accompanying drawings.

FIG. 1 is a plan view of an embodiment of the vibratory apparatus illustrated in a seasoning application.

FIG. 2 is an elevation view of an embodiment of the vibratory apparatus illustrated in a seasoning application.

FIG. 3 is a partial perspective view of the inverting station of the vibratory apparatus.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

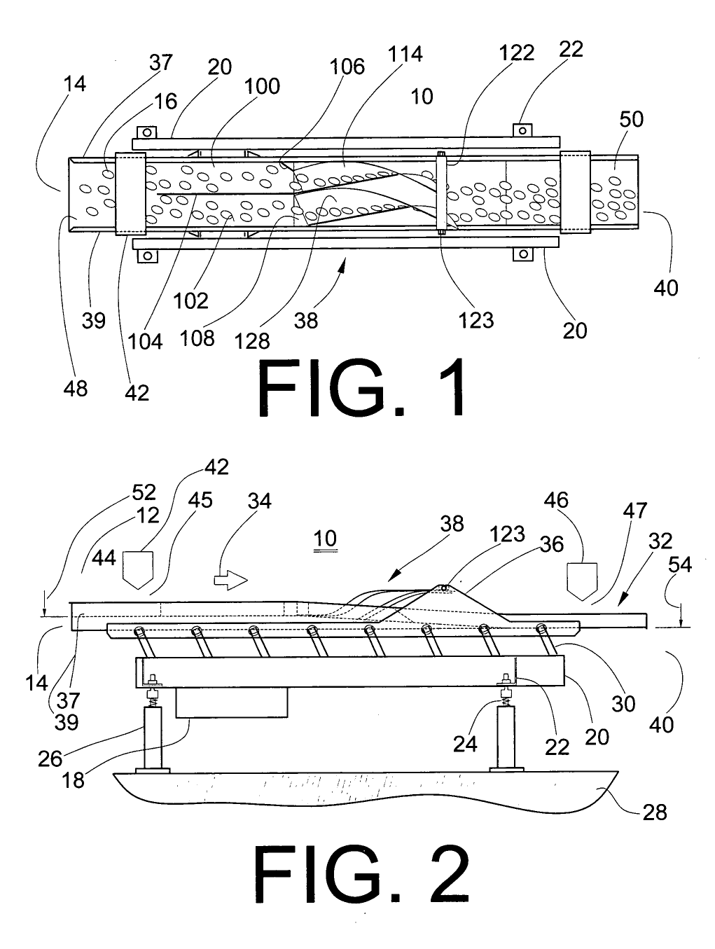

A preferred embodiment of a specialized vibratory conveyor for inverting or turning-over articles in a product stream 10 is illustrated in FIGS. 1 and 2. The specialized vibratory conveyor 10 receives a product stream 12 at an infeed 14 end of the conveyor 10. The product stream 12 is composed of a plurality of articles 16. In one application, the articles 16 may include any article, especially fungible items such as potato chips. Articles 16 such as potato chips are characterized as having a first or top side facing in an upward manner or direction, and an opposite second or bottom side facing in a downward manner or direct. In a potato chip seasoning application, both the top and bottom side of the potato chip are ideally coated with seasoning to enhance the flavor of the article 16. The specialized vibratory conveyor 10 acts to present transport, and invert or turn-over articles 16 in the product stream 12 as will be discussed in further detail below.

One of the functions of the specialized vibratory conveyor 10 is to transport the articles 16 in a manner that is well-known in the art. The specialized vibratory conveyor 10 has a vibratory drive 18 that is mounted to a frame 20. The vibratory drive 18 imparts a cyclical force to the frame 20, and in a preferred embodiment is an electromagnetic drive, although other drive topologies may be utilized without departing from the scope of this invention. In addition, the vibratory drive 18 could be mounted to other components of the specialized vibratory conveyor 10 without departing from the scope of this invention.

The frame 20 includes a set of frame brackets 22 positioned near the edges of the frame 20. The frame brackets 22 are configured to accept or otherwise couple to an isolation spring assembly 24 which serves to decrease the transmission of vibratory forces. The isolation spring assemblies 24 are mounted or borne by a set of supports or columns 26. The supports or columns 26 are positioned on a platform or floor 28. The combination of frame brackets 22, isolation springs 24, and supports or columns 26 provide a means of holding the specialized vibratory conveyor 10 in a position while minimizing transmitted vibratory forces. The art is replete with numerous other holding or support means which could be applied with equal success without departing from the scope of this invention.

Still referring to FIGS. 1 and 2, one end of each of a plurality of arm spring assemblies 30 is attached to the frame 20. An opposite end of each of the plurality of arm spring assemblies 30 is attached to either of a pair of arm support plates 36. A conveying trough 32 is welded or otherwise fastened to the arm support plates 36. The conveying trough 32 includes a first and second sidewall 37 and 39 which act to provide rigidity to the conveying trough 32 and to contain the articles 16 as they are transported. The conveying trough 32 then is resiliently supported by the arm assemblies 30, which, in combination, acts as a spring-mass system which responds to a vibratory force provided by the vibratory drive 18 so the conveying trough 32 translates in an oscillatory or cyclical manner acting to transport the articles 16 in the product stream 12 in a flow direction generally depicted by the arrow 34. The specialized vibratory conveyor 10 transports articles 16 from the infeed end 14 of the conveying trough 32 along an infeed vibrating conveying surface 48, and through an inverting station 38, and then to a discharge vibrating conveying surface 50 at the discharge end 40 of the conveying trough 32. The infeed vibrating conveying surface 48 is positioned at a first elevation generally depicted by the dimension 52. The discharge vibrating conveying surface 54 is positioned at a second elevation generally depicted by the dimension 54. The magnitude of the first elevation 52 is greater than the magnitude of the second elevation 54 so that articles 16 in the product stream are transported in a downhill manner.

In a seasoning application, a first seasoning station 42 is mounted above the conveying trough 32, and between the infeed end 14 and the inverting station 38. The first seasoning station 42 applies a stream of seasoning 44 to a first side of the articles 16 that are oriented in an upward manner in the product stream 12 over a first seasoning area 45. Articles 16 in the product stream 12 are inverted or turned-over as they are transported through the inverting station 38. A second seasoning station 46 is mounted above the conveying trough 32, and between the inverting station 38 and the discharge end 40. The second seasoning station 46 applies a stream of seasoning 44 to an opposite second side of the articles 16 in the product stream 12 over a second seasoning area 47.

Referring now to FIGS. 1-3, an inverting station 38 having a first channel and second channel, 100 and 102 respectively, is shown as part of the specialized vibratory conveyor 10. The number of channels or lanes in the specialized conveyor 10 is configurable or adjustable during a design phase of the conveyor and is selected to provide an appropriate throughput level to match that needed in a production line. One skilled in the art would recognize that a single channel or lane or multiple channels or lanes could be incorporated without departing from the scope of this invention.

A channel or lane divider 104 is welded or fastened to the infeed vibrating conveying surface 48. The lane divider 104 is positioned separate the product stream 12 into two parallel streams of articles 16 to travel through either the first or second channel, 100 or 102. A diverter 106 is mounted proximate to the first side wall 37, and in an oblique manner relative to the first side wall 37. The diverter 106 is welded or otherwise affixed to the infeed vibrating conveying surface 48, and has a height that is substantially equal to the height of the lane divider 104.

A sloped conveying surface 108 is positioned between the infeed vibrating conveying surface 48 and the discharge vibrating conveying surface 50. It should be understood that the sloped conveying surface 108 is a vibrating conveying surface. The sloped conveying surface 108 is oriented in a downwardly sloping manner.

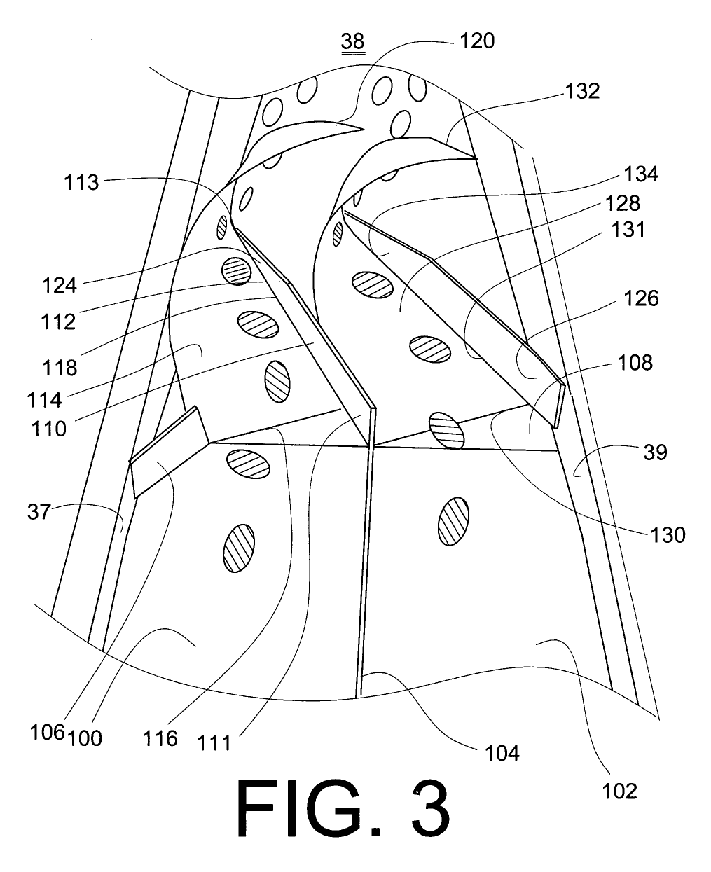

A first guide wall 110 is affixed to the sloped conveying surface 108 and extends from an intermediate position between the first side wall 37 and the second side wall 39 toward the first side wall 37 and at an oblique angle relative to the flow direction 34. The first guide wall 110 has a height value near a first end 111 that is substantially equal to the height value of the lane divider 104. This height value extends to an intermediate position 112. At the intermediate position 112, the height value of the first guide wall 110 diminishes to a point 113 forming a tapered portion or region 124 of the first guide wall 110 as shown in FIG. 3.

A first curved surface 114 has a first end 116 which is affixed to the sloped conveying surface 108. Other forms of affixing including fastening in a removable manner such as clamping. A first side 118 of the first curved surface 114 is held in contact relation to the first guide wall 110. Before forming, the first curved surface 114 has a shape that is substantially similar to a rectangle, and in preferred embodiment is fabricated using a material such as stainless steel. The first curved surface 114 is fashioned by twisting a second end 120 of the first curved surface 114 by one half turn providing a shape that resembles the shape of a ribbon with a half twist. One skilled in the art would recognize that there are other methods that could be used to produce the first curved surface 114 without departing from the scope of this invention.

The second end 120 of the first curved surface 114 is affixed to a curved surface support 122 (FIG. 1) to stabilize the second end 120. The curved surface support 122 is fastened to the arm support plate 36 as shown in FIG. 2 using a removable fastener 123 so that the first curved surface 114 can be removed. One skilled in the art would recognize that the first curved surface 114 could be fastened in a non-removable manner without departing from the scope of this invention.

A second guide wall 126 is affixed to the sloped conveying surface 108 and extends from the second side wall 39 to an intermediate position between the first side wall 37 and the second side wall 39, and towards the first side wall 37 and at an oblique angle, and in parallel relation to the first guide wall 110. The second guide wall 126 has a height profile that is substantially similar to a height profile of the first guide wall 110.

A second curved surface 128 has a first end 130 which is affixed to the sloped conveying surface 108. A first side 131 of the second curved surface 124 is held in contact relation to the second guide wall 126. The second curved surface 124 is formed in a similar manner to the first curved surface 114, so that it resembles the shape of a ribbon with a half twist. A second end 132 of the second curved surface 124 is stabilized and held to the curved surface support 122 (FIG. 1).

A positional relationship exists between the tapered portion or region 124 of the first guide wall 110 and the first curved surface 114. This relationship is related to an inverting accuracy or performance and can be determined empirically for a specific application such as potato chips. A similar positional relationship exists between the second curved surface 124, and the tapered section or region 134 of the second guide wall 126.

### Operation

The operation of the present invention is believed to be readily apparent and is briefly summarized in the paragraphs which follow.

In operation, and referring to FIGS. 1 and 2, the vibratory drive 18 provides an oscillatory driving force to the frame 20. A plurality of isolation springs 24 coupled to a set of frame brackets 22 reduce the transmission of the oscillatory driving force to a set of columns or supports 26 that are mounted on the platform or floor 28.

A plurality of arm springs 30 are mounted to both the frame 20 and the arm support plate 36 which is secured to the conveying trough 32. The arms springs 30 provide a resilient support and mechanism to couple the oscillatory driving force from the frame 20 to the conveying trough 32 thus translating or moving the conveying trough 32 in a vibratory manner which is useful for conveying and inverting articles in a product stream.

Now referring to FIGS. 1-3, the product stream 12 is deposited on the infeed vibratory conveying surface 48 where the articles 16 have a first side facing in an upward manner, and are transported through the lanes or channels 100 and 102.

Some articles 16 in the first lane or channel 100 encounter the diverter 106 and are guided to the sloped conveying surface 108 where they are transported to the first curved surface 114.

Then, articles 16 are transported along the first curved surface 114 by vibratory force, and are increasingly urged toward the first guidewall 110 by the force of gravity due to an increasing side angle exhibited by the first curved surface 114 as the articles 16 travel a path defined by the first curved surface 114. As the articles 16 approach the tapered region 124 of the first guide wall 110, the articles 16 begin to roll as they continue to be urged toward the first guide wall 110. Then, at some point proximate to the tapered region 124 of the first guide wall 110, the articles 16 roll over the first guide wall 110, and are effectively released from the first curved surface 114 to the vibrating sloped conveying surface 108 so that the first side of the articles 16 assume a downward facing direction or manner as they contact the vibratory sloped conveying surface 108.

Then, the articles 16 continue to travel along the vibrating sloped conveying surface 108, finally reaching the discharge vibrating conveying surface 50 where they are released.

Other articles 16 in the second lane or channel 120 are guided to the sloped conveying surface 108 where they are transported to the second curved surface 124.

The articles 16 are transported along the second curved surface 124 by vibratory force, and are increasingly urged toward the second guidewall 126 by the force of gravity due to the increasing side angle exhibited by the second curved surface 124. As the articles 16 approach the tapered region 134 of the second guide wall 126, the articles 16 begin to roll as they continue to be urged toward the second guide wall 126. Then, at some point proximate to the tapered region 134 of the second guide wall 126, the articles 16 roll over the second guide wall 126, and are effectively released from the second curved surface 126 to the vibrating sloped conveying surface 108 so that the first side of the articles 16 assume a downward facing direction or manner as they contact the vibratory sloped conveying surface 108.

Then, the articles 16 continue to travel along the vibrating sloped conveying surface 108, finally reaching the discharge vibrating conveying surface 50 where they are released.

Now referring to FIGS. 1 and 2, in a spicing application, articles 16 in the product stream 12 have a first side oriented in an upward facing manner are transported beneath the first seasoning station 42. Here, the first side of the articles 16 are coated with a seasoning as they are transported from the infeed vibrating conveying surface 14 to the first or second curved surfaces 114 and 124 respectively. Then, as discussed previously, articles 16 are inverted or turned over so that the first side of the articles 16 that have been coated are inverted or turned over so that they are facing in a downward direction or manner after exiting the first and second curved surfaces 114 and 124 respectively. In this manner, the second, and uncoated side, which is opposite the first side of the articles 16 is exposed in an upward facing manner. Then, the articles 16 are transported beneath the second seasoning station 46. Here, the second side of the articles 16 are coated with a seasoning as they are transported between the first and second curved surfaces 114 and 124, and the discharge vibrating conveying surface 40.

In compliance with the statute, the invention has been described in language more or less specific as to structural and methodical features. It is understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A vibratory apparatus for inverting articles in a product stream, comprising:
a vibrating conveying surface having an infeed and a discharge and configured to transport the product steam from the infeed and to the discharge in a flow direction;
a first guide wall positioned at an angle relative to the flow direction, and borne by the vibrating conveying surface;
a first curved surface positioned adjacent to a portion of the first guide wall, and borne by the vibrating conveying surface, and defining a path that is at least partially characterized by a ribbon with a half twist;
and wherein the articles are transported by and along a portion of the first curved surface and are inverted or turned-over as they are transferred from the first curved surface to the vibrating conveying surface.

2. The vibratory apparatus for inverting articles as claimed in claim 1, further comprising:
a lane divider borne by the vibrating conveying surface defining a lane, and wherein a portion of the product stream is routed through the lane;
a second guide wall positioned parallel to the first guide wall;
a second curved surface positioned adjacent to a portion of the second guide wall, and borne by the vibrating conveying surface, and defining a path that is at least partially characterized by a ribbon with a half twist;
and wherein articles are transported by and along a portion of the second curved surface and are inverted or turned-over as they are transferred from the second curved surface to the vibrating conveying surface.

3. The vibratory apparatus for inverting articles as claimed in claim 1, and wherein the first guide wall has a first end and an opposite second end, and the first guide wall has a first height from the first end to an intermediate position between the first and second end, and a tapered region beginning at the intermediate position and extending to the second end.

4. The vibratory apparatus for inverting articles as claimed in claim 3, and wherein the first guide wall is positioned so that articles transported by the first curved surface interact with the tapered region of the first guide wall as they are transferred from the first curved surface to the vibrating conveying surface.

5. The vibratory apparatus for inverting articles as claimed in claim 4, and wherein the vibrating conveying surface at the infeed has a first elevation, and wherein the vibrating conveying surface at the discharge has a second elevation, and wherein the first elevation is greater than the second elevation.

6. The vibratory apparatus for inverting articles as claimed in claim 1, and wherein the first curved surface is fastened to the vibratory conveying surface in removable fashion.

7. The vibratory apparatus for inverting articles as claimed in claim 1, further comprising:
defining a first seasoning area located between the infeed of vibrating conveying surface and the first curved surface, and configured to accommodate a first seasoning station operable to distribute seasoning on one side of articles passing thereunder; and
defining a second seasoning area located between the first curved surface and the discharge of the vibrating conveying surface and, and configured to accommodate a second seasoning station operable to distribute seasoning an opposite side of articles passing thereunder.

8. The vibratory apparatus for inverting articles as claimed in claim 1, further comprising:
a diverter borne by the vibrating conveying surface and located between the infeed of the vibrating conveying surface and the first curved surface, and configured to guide articles that come in contact with the diverter toward the first curved surface.

9. A vibratory apparatus for inverting articles in a product stream, comprising:
a vibrating conveying surface having an infeed at a first elevation, and a discharge at a second elevation, and configured to transport the product steam from the infeed to the discharge in a flow direction;
a first guide wall positioned at an angle relative to the flow direction, and borne by the vibrating conveying surface, and wherein the first guide wall has a first end and an opposite second end, and wherein the first guide wall has a first height extending from the first end to an intermediate position between the first and second end, and a tapered region beginning at the intermediate position and extending to the second end;
a first curved surface positioned adjacent to a portion of the first guide wall, and borne by the vibrating conveying surface;
and wherein the articles are transported by and along a portion of the first curved surface and are inverted or turned-over as they are transferred from the first curved surface to the vibrating conveying surface.

10. The vibratory apparatus for inverting articles as claimed in claim 9, and wherein the first guide wall is positioned so that articles transported by the first curved surface are released to the vibrating conveying surface proximate to the tapered region of the first guide wall.

11. The vibratory apparatus for inverting articles as claimed in claim 10, and wherein the vibrating conveying surface at the infeed has a first elevation, and wherein the vibrating conveying surface at the discharge has a second elevation, and wherein the first elevation is greater than the second elevation.

12. A method for inverting articles in a product stream, comprising:
providing a vibrating conveying surface having an infeed and a discharge;
providing a first guide wall that is borne by the vibrating conveying surface, and having a first end and an opposite second end, and wherein the first guide wall has a first height extending from the first end to an intermediate position between the first and second end, and a tapered region beginning at the intermediate position and extending to the second end;
providing a first curved surface positioned adjacent to a portion of the first guide wall, and borne by the vibrating conveying surface;
transporting articles oriented with a first side facing in an upward manner from and along the vibrating conveying surface to the first curved surface;
transporting the articles along a portion of the first curved surface so that the articles begin to roll as they are urged toward the first guide wall;
releasing the articles from the first curved surface to the vibrating conveying surface so that the first side of the articles assume a downward facing direction as they contact the vibratory conveying surface;
transporting the articles oriented with the first side facing in a downward manner as they are transported to the discharge.

13. The method for inverting articles in a product stream as claimed in claim 12, and wherein the infeed of the vibratory conveying surface has a first elevation, and the discharge of the vibratory conveying surface has a second elevation, and wherein the first elevation is greater than the second elevation.

14. The method for inverting articles in a product stream as claimed in claim 13, and wherein the articles are released from the first curved surface to the vibrating conveying surface proximate to the tapered region of the first guide wall.

15. The method for inverting articles in a product stream as claimed in claim 14, further comprising:
coating the first side of the articles with a seasoning as they are transported between the infeed of the vibrating conveying surface to the first curved surface;
coating the second side of the articles with a seasoning as they are transported between the first curved surface and the discharge of the vibrating conveying surface.

16. The method for inverting articles in a product stream as claimed in claim 14, and wherein the first guide wall is releasably fastened to the vibrating conveying surface.

17. The method for inverting articles in a product stream as claimed in claim 14, further comprising:
providing a diverter positioned between the infeed of the vibrating conveying surface and the first curved surface;
guiding some articles in the product stream onto the first curved surface by contacting the diverter.

18. The method for inverting articles in a product stream as claimed in claim 14, and wherein the first curved surface has a shape that defines a path that is at least partially characterized by a ribbon with a half twist.

19. The method for inverting articles as claimed in claim 17, further comprising:
providing a lane divider borne by the vibrating conveying surface defining a lane, and wherein a portion of the product stream is routed through the lane;
providing a second guide wall positioned parallel to the first guide wall;
providing a second curved surface positioned adjacent to a portion of the second guide wall, and borne by the vibrating conveying surface;
transporting articles oriented with a first side facing in an upward manner from and along the vibrating conveying surface to the second curved surface;
transporting the articles along a portion of the second curved surface so that the articles begin to roll as they are urged toward the second guide wall;
releasing the articles from the second curved surface to the vibrating conveying surface so that the first side of the articles assume a downward facing direction as they contact the vibratory conveying surface;
transporting the articles oriented with the first side facing in a downward manner as they are transported to the discharge.

20. The method for inverting articles in a product stream as claimed in claim 19, and wherein each of the first and second curved surfaces each have a shape that defines a path that is at least partially characterized by a ribbon with a half twist.
